(19) United States
(12) Patent Application Publication
(10) Pub. No.: US 2026/0187872 A1
(43) Pub. Date: Jul. 2, 2026

(54) METHOD FOR GENERATING IMAGES FOR AI TRAINING

(71) Applicant: FPT USA CORP., Richardson, TX (US)

(72) Inventors: Hung Quoc CAO, Quy Nhon City (VN); Long TRAN-THANH, Quy Nhon City (VN); Thu Anh Hong LE, Quy Nhon City (VN)

(73) Assignee: FPT USA CORP., Richardson, TX (US)

(21) Appl. No.: 19/003,204

(22) Filed: Dec. 27, 2024

(51) Int. Cl. G06T 11/60; G06V 10/764; G06V 10/774

(52) U.S. Cl. CPC G06T 11/60; G06V 10/764; G06V 10/774

(57) ABSTRACT

The present disclosure relates to a method and an apparatus for generating images for AI training. The method for generating images for AI training may comprise the steps of: receiving a reference image and a first set of one or more prompts asking about one or more properties in the reference image; based on the first set of prompts, transforming, by a first large language model, LLM, the reference image into a set of one or more properties; generating, by a second LLM, a second set of one or more prompts from the set of properties; generating one or more images by using the second set of prompts; converting the set of properties into a corresponding set of questions, each question is to confirm the presence or absence of the corresponding property in an image; confirming, by the first LLM, the presence or absence of each property in the set of properties in each of the images by using the set of questions; and classifying each of the images to be an image for AI training or not based on the ratio between the number of properties confirmed as being present in the image and the total number of properties in the set of properties.

### CROSS-REFERENCE TO RELATED APPLICATIONS

Not Applicable

### TECHNICAL FIELD

The present disclosure relates to the field of artificial intelligence (AI) technology, and in particular, relates to a method and a system for generating images for AI training.

### BACKGROUND ART

Artificial Intelligence (AI) is a scientific field that is related to building computers as well as machines that can learn, reason and act in such a way that would normally require the intelligence of humans, or that includes data of which the scale goes beyond what humans can analyze. AI is an ability of a machine to replicate or enhance human intelligence, such as learning and reasoning from experiences. AI has been used in computer programs for many years, and is now applied to a variety of other products and services.

Many AI models require a vast amount of training data. For example, an AI model for classifying objects in images needs thousands or millions of images of the objects to differentiate each of them from one another, and the larger the number of the images, the better the classifying result is.

To collect the image data for such training, an obvious solution can be capturing the images from cameras in real life. However, not every type of image can be captured in real life, and there are limitations as to time, space, objects, resources and other conditions.

Images found from search engines can be used for training. However, the queries (or prompts) used for searching may be insufficient, or there may be difficulties for a user to find relevant words to describe what he/she is looking for. Moreover, the number of prompts that a user can think of may be limited. The manual search by human also creates an obstacle to collect enough images for AI training. Some search engines allow to search by images. However, in many situations, the result is not satisfactory, as the found images might contain too many objects and might not focus on the objects of interest.

Another source can be generated images, where generative AI applications generate the images from prompts. This solution also faces the difficulty of unclear prompts, or limited number of prompts.

Further, there are situations where the number of found/generated images may be limited. For example, images with sensitive subject such as weapons or violent scenes might not be retrieved from a search engine under restrictions of laws or regulations. Yet these images are necessary for applications such as surveillance and security, and the lack of training data makes it difficult to improve the quality of such AI applications.

Another problem to the solutions is the quality of the result images. The lack of sufficient prompts also leads to the degradation of focus on the objects of interest in the result images due to the repeated prompts. Further, some generated images might have defects such as irregularities, unrealistic objects, and the like, and there is a need to classify these images as inappropriate. Again, the classification whether an image can be an appropriate input for AI training is usually done manually by human, which is time-consuming and unproductive.

### SUMMARY

The present disclosure provides a method and system for generating images for AI training, which combines text and image inputs for prompt orientation, and provides a variety of prompts to create more images even for sensitive subjects and a mechanism for automated classification of the generated images.

According to a first aspect, the present disclosure provides a method for generating images for AI training, the method may comprise:
receiving a reference image and a first set of one or more prompts asking about one or more properties in the reference image;
based on the first set of prompts, transforming, by a first large language model, LLM, the reference image into a set of one or more properties;
generating, by a second LLM, a second set of one or more prompts from the set of properties;
generating one or more images by using the second set of prompts;
converting the set of properties into a corresponding set of questions, each question is to confirm the presence or absence of the corresponding property in an image;
confirming, by the first LLM, the presence or absence of each property in the set of properties in each of the images by using the set of questions; and
classifying each of the images to be an image for AI training or not based on the ratio between the number of properties confirmed as being present in the image and the total number of properties in the set of properties.

In a possible implementation, the properties to be asked in the reference image may include people, places, activities and/or weapons.

In a possible implementation, the method may further comprise, after the transformation of the reference image and before the generation of the second set of prompts, receiving a set of properties modified by a user, wherein the modification may comprise a change, an addition and/or a removal of one or more properties in/to/from the set of properties.

In a possible implementation, the generating of one or more images may comprise searching, by an image search engine, to retrieve one or more images from the second set of prompts.

In a possible implementation, the generating of one or more images may comprise generating, by a text-to-image model, one or more images from the second set of prompts.

In a possible implementation, the classifying of each of the images may comprise classifying the image as an image for AI training if the ratio is more than or equal to a first predetermined threshold. In a possible implementation, the classifying of each of the images may further comprises classifying one or more images chosen by a user from the images with the ratio lower than the first threshold and higher than a second threshold as images for AI training, wherein the second threshold is lower than the first threshold.

According to a second aspect, the present disclosure provides a system for generating images for AI training, the system may comprise:
a receiver configured to receive a reference image and a first set of one or more prompts asking about one or more properties in the reference image;
a first large language model, LLM, configured to transform, based on the first set of prompts, the reference image into a set of one or more properties;
a second LLM configured to generate a second set of one or more prompts from the set of properties;
a generator configured to generate one or more images by using the second set of prompts;
a converter configured to convert the set of properties into a corresponding set of questions, each question is to confirm the presence or absence of the corresponding property in an image;
wherein the first LLM confirms the presence or absence of each property in the set of properties in each of the images by using the set of questions; and
a classifier configured to classify each of the images to be an image for AI training or not based on the ratio between the number of properties confirmed as being present in the image and the total number of properties in the set of properties.

In a possible implementation, the properties to be asked in the reference image may include people, places, activities and/or weapons.

In a possible implementation, the receiver may be further configured, after the transformation of the reference image and before the generation of the second set of prompts, to receive a set of properties modified by a user, wherein the modification may comprise a change, an addition and/or a removal of one or more properties in/to/from the set of properties.

In a possible implementation, the generator may be configured to use the second set of prompts against an image search engine to retrieve one or more images.

In a possible implementation, the generator may comprise a text-to-image model configured to generate one or more images from the second set of prompts.

In a possible implementation, the classifier may be configured to classify the image as an image for AI training if the ratio is more than or equal to a first predetermined threshold. In a possible implementation, the classifier may be further configured to classify one or more images chosen by a user from the images with the ratio lower than the first threshold and higher than a second threshold as images for AI training, wherein the second threshold is lower than the first threshold.

According to another aspect, the present disclosure provides a computer program comprising instructions which, upon being executed by a computing device having one or more processors, cause the one or more processors to perform the method according to the first aspect of present disclosure.

According to yet another aspect, the present disclosure provides a computer-readable storage medium having stored thereon a computer program, the computer program comprising instructions which, upon being executed by a computing device having one or more processors, cause the one or more processors to perform the method according to the first aspect of present disclosure.

According to the present disclosure, the method and system for generating images for AI training can overcome some or all of the above-mentioned limitations, for example, but not limited to, the lack of prompt orientation, images for sensitive subjects and a mechanism for automated classification of the generated images.

The effects of the present disclosure should not be limited to the above-mentioned effects, and other effects that are not mentioned in the present disclosure will be apparently understood by those skilled in the art from the description and the appended claims.

### BRIEF DESCRIPTION OF DRAWINGS

In the drawings:

FIG. 1 is a schematic diagram illustrating a method for generating images for AI training according to an embodiment of the present disclosure;

FIG. 2 is a schematic diagram illustrating a method for generating images for AI training according to another embodiment of the present disclosure;

FIG. 3 is a schematic diagram illustrating an image generating part of a system for generating images for AI training according to an embodiment of the present disclosure;

FIG. 4 is a schematic diagram illustrating a part for classifying the images generated from the image generating part of the system in FIG. 3; and

FIG. 5 is a block diagram illustrating an exemplary computer architecture for implementing aspects of the present disclosure, according to some embodiments of the present disclosure.

### DETAILED DESCRIPTION

Advantages and characteristics of the present disclosure and a method of achieving the same will be made to be clear by referring to exemplary embodiments described in detail below together with the accompanying drawings. However, the present disclosure is not limited to the exemplary embodiments disclosed herein but may be implemented in various forms. The exemplary embodiments are provided by way of example only so that an ordinary skilled in the art can fully understand the present disclosure.

The features of various embodiments of the present disclosure can be partially or entirely combined with each other and can be operated in various ways, and the embodiments can be carried out independently of or in association with one another.

The order of steps or order for performing certain actions is immaterial as long as the present disclosure remains operable. That is, a certain step may occur in an order different from that described herein, or concurrently with another step.

When the terms such as “after,” “subsequent to,” “next to,” “before,” and the like, are used for describing a temporal relationship, cases where any two events are not consecutive or not sequential may be included, unless the term “immediately” or “directly” is explicitly used. That is, one or more other events may occur between those two events, unless a more limiting term such as “just,” “immediate(ly),” or “direct(ly)” is used.

The terms such as “comprising,” “including,” “having,” and “consist of” used herein are generally intended to allow other components to be added unless the terms are used with the term “only”.

Unless otherwise defined, terms used herein (including technical and scientific terms) have common meanings that would normally be interpreted by an ordinary skilled in the art. Further, terms such as those defined in commonly used dictionaries should be interpreted as having a meaning consistent with their meaning in relevant art and should not be interpreted in an idealized or overly formal sense, unless expressly defined otherwise.

Although the terms “first,” “second,” and the like are used for describing various components, these components are not confined by these terms. These terms are merely used for distinguishing one component from the other components. Therefore, a first component to be mentioned below may be a second component in a technical concept of the present disclosure.

Any references to singular may include plural unless expressly stated otherwise. And “a plurality of” means two or more. Further, the phrase “at least one” should be understood as including any and all combinations of one or more of listed items. For example, each of the phrases “at least one of a first item, a second item, or a third item” and “at least one of a first item, a second item, and a third item” may represent a combination of two or more of the first item, the second item, and the third item, or may represent only one of the first item, the second item, or the third item.

Like reference numerals generally denote like elements throughout the specification.

In the following description of the present disclosure, “/” means “or” unless otherwise specified. For example, A/B may represent A or B. In this specification, “and/or” describes only an association relationship for describing associated objects and represents that three relationships may exist. For example, A and/or B may represent the following three cases: Only A exists, both A and B exist, and only B exists.

In the following description of the present disclosure, a detailed explanation of known related technologies may be omitted to avoid unnecessarily obscuring the subject matter of the present disclosure.

The present disclosure will now be described in reference to the accompany drawings.

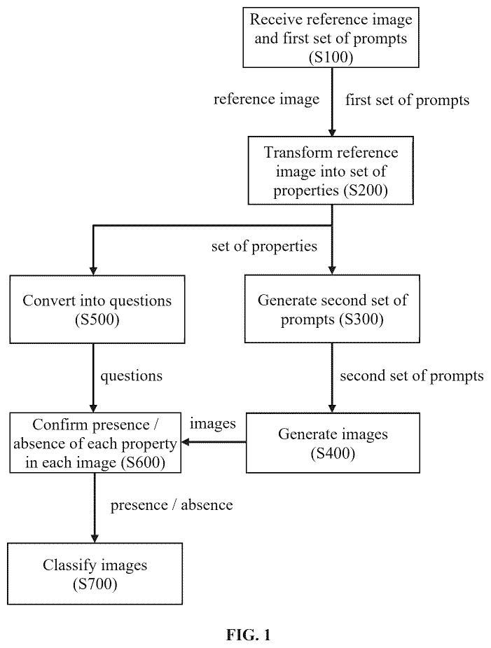

FIG. 1 is a schematic diagram illustrating a method for generating images for AI training according to an embodiment of the present disclosure. As shown in FIG. 1, a reference image and a first set of prompts are received (S100). This can be done by a user inputting the reference image into a receiver 1, for example, a link to the image stored in a local storage or a remote URL, and prompts into a text box on an interface of a software. Without limitation, the image can also be captured directly from a camera and loaded into the receiver 1. The prompts can also be pre-prepared and/or stored on a storage medium and loaded into the receiver 1, and there is no limitation thereto. The reference image serves as an orientation to generate similar images, or images with the same or similar objects or with the same or similar subject. Here, the first set of prompts are those to also navigate the image generation by asking/requesting to extract the properties of the image. The properties may be the types of the objects of interest, the attributes that the objects should have, or the actions of the object in the image, but not limited thereto. In a possible embodiment, for the generation of images for surveillance or security, and specifically for weapon detection, the properties may be people, places, activities and/or weapons, but not limited thereto. Some examples of the prompts can be “Who are in the image? Where are they? What are they doing? What types of weapons are in the picture? Describe the weapons.”, and the like. The number of properties is preferably 3, 4, or 5, but not limited thereto, and any number of properties can be used, as required by the purpose of the training. By using the combination of the reference image and the first set of prompts, it can be expected that the generated images are more relevant to the subject in terms of the objects of interest, their surrounding environment and their actions, and the like.

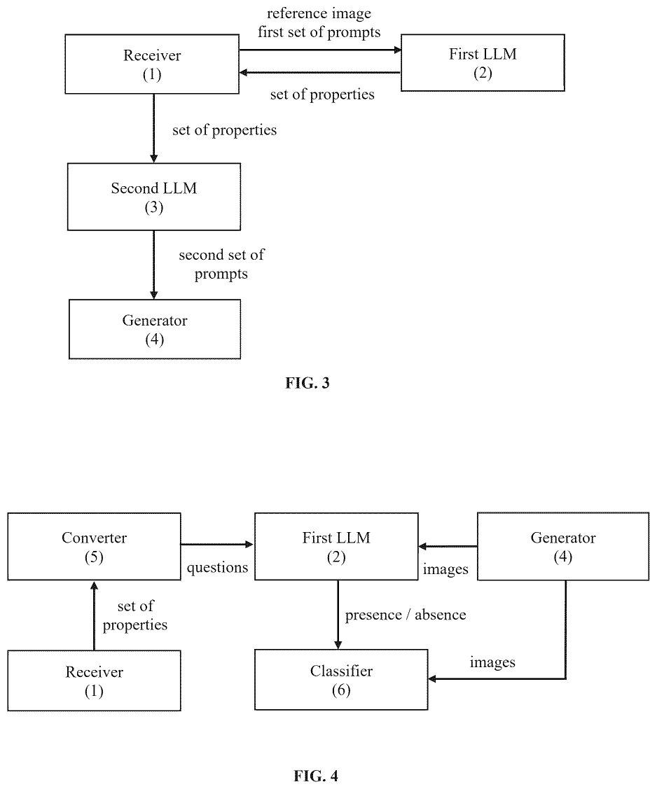

As shown in FIGS. 1 and 3, the reference image and the first set of prompts are forwarded by the receiver 1 to a first large language model (LLM), where they are transformed into a set of properties (S200). Here, the first set of prompts are input into the first LLM to ask/request the LLM to extract the information from the reference image, such information is the properties, and the extracted properties can be collected as the set of properties. For example, the properties can be: “two men” (for people), “bus station” (for place), “fighting” (for activity), and “knife” (for weapon). The set of properties may be returned to the receiver for further processing. However, it is not limited thereto, and another receiver can be configured to receive the set of properties and implement the steps of processing the properties as described-below. In a preferred embodiment, the first LLM may include an image-to-text model, and preferably, a Visual Question Answering (VQA) model. Examples of the first LLM may include a customized model of ChatGPT, Llama, Google Gemini, MS Copilot, Claude, or the like.

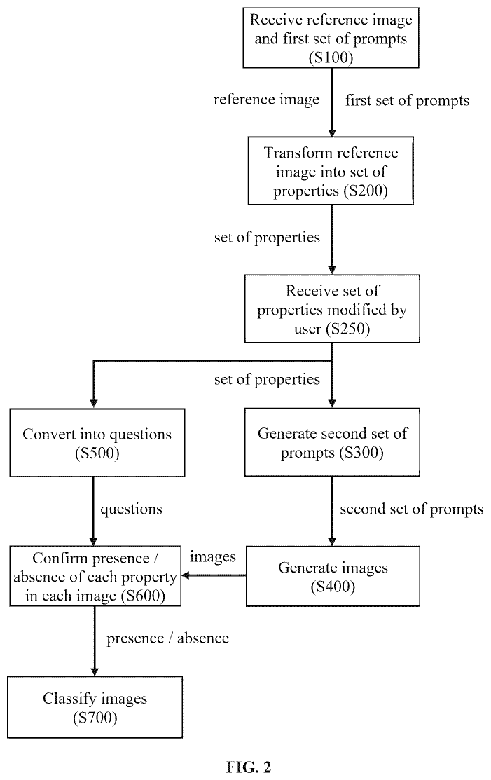

Referring to FIG. 2, in a possible embodiment, the set of property can be provided to a user, for example, in the form of interactive elements on a display. This is to enable the user to review the extracted properties and make modifications as he/she requires. By allowing the user to modify the properties, the properties can describe the objects, actions, environments, etc. in the reference image more precisely, and thereby enhance the quality of the result generated images. The modification may include the change of one or more property. For example, the environment can be changed from “bus station” to “train station”, “two men” to “a men and a child”, “fighting” to “kidnapping”, “knife” to “cleaver”, or the like. The modification may include the addition of one or more property. For example, a weather condition, such as “foggy” can be added. The modification may also include the removal of one or more property. For example, to generate more generic images, the environment “bus station” can be removed, so that there is no requirement on the place of the image to be generated. As shown in FIG. 2, the receiver may receive the set of properties from the user after the modification is complete (S250). The implementation of other steps in FIG. 2 are similar to those of FIG. 1, and the repeated descriptions therefor are omitted.

Referring back to FIGS. 1 and 3, the set of properties may be forwarded to a second LLM, configured to generate a second set of one or more prompts from the set of properties (S300). Here, the second LLM may first diversify each of the properties into many properties of the same type or of similar types. For example, the property “knife” can be diversified into “knife”, “cleaver”, “switchblade”, and the like, the property “two men” can be diversified into “a man and a kid”, “two robbers”, “two women”, “a pair”, or the like. The second LLM may include a prompt format database where formats to create prompts are stored, or the second LLM may receive the prompts from such an external prompt format database. Alternatively, the second LLM can create the formats as needed. The diversified properties may be inserted respectively to each syntax element in each format to generate the second set of prompts that has a large number of prompts. For each prompt format, the number of prompts can be as large as the number of combinations of diversified properties used with that format, and the total number of prompts can be the sum of prompts for each format. Therefore, the implementation of the second LLM can provide a variety of prompts to generate more images, even for sensitive subjects such as weapon detection. As an example, any LLM sufficient for generating prompts from properties, syntax elements, keywords, text or the like can be used.

The generated second set of prompts can be provided to a generator 4 configured to generate one or more images (S400). In an example, the generator can be any application capable of generating images from prompts. In a possible embodiment, the generator can be configured to use the second set of prompts against an image search engine to retrieve one or more images. Each prompt can be inserted into the search engine, and the result images can be received from the search engine. The prompts can also be inserted into the search engine in batch, or in any combination thereof. The image search engine can be any search engine capable to retrieve images from prompt, text, keywords, syntax element, or the like, and there is no limitation thereto. The image search engine, for example, can be a conventional search engine such as Google Images, Bing Image Search, Baidu Image Search, Yandex Images, or the like. In another possible embodiment, the generator can also include a text-to-image model configured to generate one or more images from prompts. Each prompt can be input into the model, and the generated images can be received from the model. The prompts can also be input in batch, or in any combination thereof. The text-to-image model can be any model capable to generate images from prompt, text, keywords, syntax element, or the like, and there is no limitation thereto. The text-to-image model, for example, can be a customized model of a common model, such as ChatGPT, Llama, Google Gemini, MS Copilot, Claude, or the like. It should be noted that the prompts can also be inserted in both a search engine and a text-to-image model, and there is no limitation thereto.

In another embodiment, the present disclose relates to a process for automated classification of the generated images to confirm images that are sufficient for AI training. Referring to FIGS. 1 and 4, the set of properties can be converted, by a converter, into a corresponding set of questions (S500). The purpose of the questions is to be utilized by an LLM to confirm the presence or absence of the corresponding property in an image, as a score for evaluating the sufficiency of the generated image for AI training. The idea is that the more properties present in an image in comparison to the number of the properties in the set, the more sufficient the image. The converter can be any application or component capable of converting text, keywords, or syntax elements into an appropriate question in the form of Yes/No, True/False, 1/0, Confirmed/Not Confirmed, or the like. Some examples of the questions can be “Is/Are [the property] present in the image?”, “Does/Do [the property] present in the image?”, “[The property] is/are in the image, true or false?”, “Tell whether [the property] appears/appear in the image, and answer in the form of “1” for affirmation and “0” otherwise.”, and the like. The converter can be in the form of any automated text processor, word editor, or any computer program, code(s), or instruction(s) for text/keywords/syntax element manipulation, or the like.

Referring back to FIGS. 1 and 4, the set of questions can be provided to the first LLM where, for each of the generated images, each of the properties in the set of properties is confirmed as present or absent (S600). Here, each question can be input into the first LLM, and the output can be the answer of the LLM on the presence or absence of the property in the image by the appropriate value, such as Yes/No, True/False, 1/0, Confirmed/Not Confirmed, or the like. It should be noted that although in a preferred embodiment, the first LLM is utilized for the confirmation of the properties, since it is the same LLM that transforms the reference image and the first set of prompts into the properties, any large language model can be used for the confirmation, and the present disclosure is not limited thereto.

Still referring to FIGS. 1 and 4, the answers of the LLM of the presence/absence of each property and the corresponding image can be input into a classifier 6, where the classifier is configured to classify each of the images as an image for AI training or not based on the ratio between the number of properties confirmed as being present in the image and the total number of properties in the set of properties (S700). Here, the ratio can be measured by the sum of the present properties divided by the total number of properties in the set. It can be represented by a number in the range of 0 to 1, a percentage (%) or any number such as fractions, or the like.

In an embodiment, the classifier may be configured to classify the image as an image for AI training if the ratio is more than or equal to a first predetermined threshold. Correspondingly to the ratio, the first threshold can be in the same unit, and may be used to qualify each image as sufficient for AI training. The first threshold, for example, can be 70%, which means, e.g., for a set of 10 properties, an image with 7 properties present therein or more can be an image for training the target AI. In an embodiment, the first threshold can be set by a user, or it can be a default value. Thereby, the classification can be automated, in which every image containing the number of properties larger than the number equivalent to the threshold is classified to be a training image. In an embodiment, the threshold can be reset by a user to be higher or lower, depending on the specific requirement of the training and/or the number of properties in the property set, the required number of generated images, or the like. The images classified as sufficient, in an example, can be stored in a storage medium for later use as training images for AI applications.

In an embodiment, the classifier can also discard the image, if the ratio is less than or equal to a second predetermined threshold. Here, an image with a low ratio means there is too few properties exist in the image, and it will not be sufficient for AI training. As an example, the second threshold can be 30%, which means, e.g., for a set of 10 properties, an image with 3 properties present therein or less cannot be an image for training the target AI. In an embodiment, the second threshold can be set by a user, or it can be a default value. Thereby, the classification can be automated, in which every image containing the number of properties smaller than the number equivalent to the threshold is classified to be insufficient as a training image. In an embodiment, the threshold can be reset by a user to be higher or lower, depending on the specific requirement of the training and/or the number of properties in the property set, the required number of generated images, or the like. In an embodiment, the second threshold is lower than the first threshold. As for the remaining images, that is, those with the ratio lower than the first threshold and higher than the second threshold, one or more images of these images can be classified as sufficient for AI training if they are chosen by a user. To this end, in an example, these images can be displayed to the user, and he/she can choose one or more images based on a specific criterion or as needed. For example, if the AI to be trained is for weapon detection, an image which contains a weapon can be chosen regardless of the number of other properties present. Hence, the chosen images can be classified as sufficient, and in an example, stored in a storage medium for later use as training images for AI applications.

It should be noted that the first and second large language models mentioned above can be separate large language models, or they can be combined into one, with no specific limitation. Each model may be a customized model of a common large language model, such as ChatGPT, Llama, Google Gemini, MS Copilot, Claude, or the like.

The present disclosure also provides a computer program, the computer program comprises instructions which, upon being executed by a computing device having one or more processors, cause the one or more processors to perform the method in any of or any combination of possible implementations in the foregoing method embodiments.

The present disclosure also provides a computer-readable storage medium having stored thereon a computer program, the computer program comprises instructions which, upon being executed by a computing device having one or more processors, cause the one or more processors to perform the method in any of or any combination of possible implementations in the foregoing method embodiments.

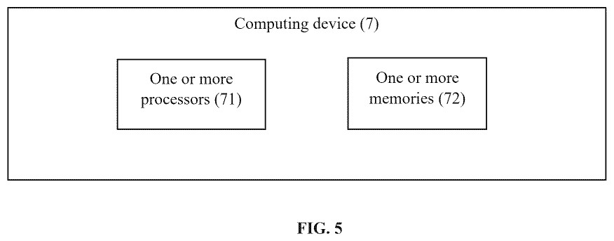

FIG. 5 is a block diagram illustrating an exemplary computer architecture for implementing aspects of the present disclosure, according to some embodiments of the present disclosure.

Referring to FIG. 5, an exemplary computer architecture may include a computing device 7 (for example, but not limited to, a general-purpose computing device). The computing device 7 may include one or more processors 71, one or more memories 72 and/or any other units. The one or more processors 71 may be, but not limited to, a general-purpose processor, an application-specific integrated circuit (ASIC), or a field-programmable gate array (FPGA). The one or more memories 72 may be, but not limited to, a non-volatile memory such as a hard disk drive (HDD), or a volatile memory such as a random-access memory (RAM). The one or more memories 72 are configured to store instructions and data. The one or more memories 72 are coupled to the one or more processors 71. In embodiments of the present disclosure, a computer program comprises instructions which, upon being executed by the computing device 7, cause the one or more processors 71 to perform the method in any of or any combination of possible implementations in the foregoing method embodiments. In other embodiments of the present disclosure, a computer-readable storage medium stores a computer program, the computer program comprises instructions which, upon being executed by the computing device 7, cause the one or more processors 71 to perform the method in any of or any combination of possible implementations in the foregoing method embodiments.

All or some of the foregoing embodiments may be implemented by software, hardware, firmware, or any combination thereof. When software is used to implement the embodiments, the embodiments may be implemented completely or partially in a form of a computer program product. The computer program product includes one or more computer instructions. When the computer program instructions are loaded and executed on a computer, all or of the procedures or functions are generated according to the embodiments of the present disclosure. The computer may be a general-purpose computer, a computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line) or wireless (for example, infrared, microwave, or the like) manner. The computer-readable storage medium may be any usable medium accessible by a computer, or a data storage device, a server or a data center, integrating one or more usable media. The usable medium may be a magnetic medium (for example, a floppy disk, a hard disk, a magnetic tape), an optical medium (for example, a DVD), a semiconductor medium (for example, a solid-state drive), or the like.

The foregoing descriptions are merely specific implementations of this application, but are not intended to limit the protection scope of this application. An ordinary skilled in the art can make modifications/changes/substitutions to the foregoing embodiments without departing from the technical scheme of the present disclosure. Any variation or replacement readily figured out by a person skilled in the art within the technical scope disclosed in this application shall fall within the protection scope of this application. Therefore, the protection scope of this application shall be subject to the protection scope of the claims.

Wherefore I/we claim:

1. A method for generating images for AI training, the method comprising:
receiving a reference image and a first set of one or more prompts asking about one or more properties in the reference image;
based on the first set of prompts, transforming, by a first large language model, LLM, the reference image into a set of one or more properties;
generating, by a second LLM, a second set of one or more prompts from the set of properties;
generating one or more images by using the second set of prompts;
converting the set of properties into a corresponding set of questions, each question is to confirm the presence or absence of the corresponding property in an image;
confirming, by the first LLM, the presence or absence of each property in the set of properties in each of the images by using the set of questions; and
classifying each of the images to be an image for AI training or not based on the ratio between the number of properties confirmed as being present in the image and the total number of properties in the set of properties.

2. The method of claim 1, wherein the properties to be asked in the reference image include people, places, activities and/or weapons.

3. The method of claim 1, further comprising, after the transformation of the reference image and before the generation of the second set of prompts, receiving a set of properties modified by a user,
wherein the modification comprises a change, an addition and/or a removal of one or more properties in/to/from the set of properties.

4. The method of claim 1, wherein the generating of one or more images comprises:
searching, by an image search engine, to retrieve one or more images from the second set of prompts.

5. The method of claim 1, wherein the generating of one or more images comprises:
generating, by a text-to-image model, one or more images from the second set of prompts.

6. The method of claim 1, wherein the classifying of each of the images comprises:
classifying the image as an image for AI training if the ratio is more than or equal to a first predetermined threshold.

7. The method of claim 6, wherein the classifying of each of the images further comprises:
classifying one or more images chosen by a user from the images with the ratio lower than the first threshold and higher than a second threshold as images for AI training, wherein the second threshold is lower than the first threshold.

8. A system for generating images for AI training, the system comprising:
a receiver configured to receive a reference image and a first set of one or more prompts asking about one or more properties in the reference image;
a first large language model, LLM, configured to transform, based on the first set of prompts, the reference image into a set of one or more properties;
a second LLM configured to generate a second set of one or more prompts from the set of properties;
a generator configured to generate one or more images by using the second set of prompts;
a converter configured to convert the set of properties into a corresponding set of questions, each question is to confirm the presence or absence of the corresponding property in an image;
wherein the first LLM confirms the presence or absence of each property in the set of properties in each of the images by using the set of questions; and
a classifier configured to classify each of the images to be an image for AI training or not based on the ratio between the number of properties confirmed as being present in the image and the total number of properties in the set of properties.

9. The system of claim 8, wherein the properties to be asked in the reference image include people, places, activities and/or weapons.

10. The system of claim 8, wherein the receiver is further configured, after the transformation of the reference image and before the generation of the second set of prompts, to receive a set of properties modified by a user,
wherein the modification comprises a change, an addition and/or a removal of one or more properties in/to/from the set of properties.

11. The system of claim 8, wherein the generator is configured to use the second set of prompts against an image search engine to retrieve one or more images.

12. The system of claim 8, wherein the generator comprises a text-to-image model configured to generate one or more images from the second set of prompts.

13. The system of claim 8, wherein the classifier is configured to classify the image as an image for AI training if the ratio is more than or equal to a first predetermined threshold.

14. The system of claim 13, wherein the classifier is further configured to classify one or more images chosen by a user from the images with the ratio lower than the first threshold and higher than a second threshold as images for AI training, wherein the second threshold is lower than the first threshold.

15. A computer program comprising instructions which, upon being executed by a computing device having one or more processors, cause the one or more processors to perform the method according to claim 1.
